(19) United States
(12) Patent Application Publication
(10) Pub. No.: US 2019/0152761 A1
(43) Pub. Date: May 23, 2019

(54) A SYSTEM FOR DISPENSING WATER, AND WATER CONTAINER TO BE USED IN SUCH SYSTEM

(71) Applicant: TRUE KEG S.R.L., Verona (IT)

(72) Inventor: Arturo DAL CORSO, ZEVIO (IT)

(73) Assignee: TRUE KEG S.R.L., VERONA (IT)

(21) Appl. No.: 16/090,065

(22) PCT Filed: Mar. 31, 2017
(86) PCT No.: PCT/IB2017/051870

§ 371 Date: Sep. 28, 2018

(30) Foreign Application Priority Data
Apr. 1, 2016 (IT) 102016000033711
Apr. 1, 2016 (IT) 102016000033720

(51) Int. Cl. B67D 3/00

(52) U.S. Cl. CPC B67D 3/0067; B67D 2001/0812; B67D 3/0035

(57) ABSTRACT

A system for dispensing water (L) comprising at least one container (5) for the water including an generally cylindrical shaped enlarged portion (6) and one neck (7), a column-type dispenser (2) including valve means for the selective water outflow and a seat (3) to seat the neck (7) of the container (5), so that in operating position the neck (7) of the container (5) is placed below with respect the enlarged portion (6). The container (5) further includes a outer rigid support structure (10) made of polymeric material which includes the enlarged portion (6) and the neck (7) and a deformable food bag (20) susceptible to internally contain the water (L).

### FIELD OF APPLICATION

The present invention is generally applicable to the technical field of containers for food liquid dispenser, and particularly relates to a system for dispensing water, as well as a container to be used in such system, preferably a reusable container.

### BACKGROUND OF THE INVENTION

Reusable containers for column-type automatic dispensers of food liquids, for example water, are known. The containers are made of polymeric material, usually PET, and have a cylindrical structure with a neck insertable in a seat of the dispenser, so that the container is placed upside down on the dispenser once the former is in the operative position.

The column dispensers further include water cooling means and valve means to allow a user to selectively control the water flow.

The containers are removable from the dispenser so that a user or an operator can remove the same container to replace it once exhausted with another full container.

The container is again filled with water once removed from the dispenser, so that it is reused. Usually, the container filling is carried out after the washing and the sterilization of the same container performed by qualified companies.

It is clear that these operations are complicated, long and costly, and clearly these operations have considerable effect on the price of the water container, and more generally on the price of the provision service thereof.

Furthermore, known containers during use have the risk of contamination of the food liquid, because the food liquids within the container are in contact with the air of the surrounding environment. This is evident by the formation during use of air bubbles within the container.

### SUMMARY OF THE INVENTION

Object of the present invention is to at least partially overcome the above drawbacks, by providing a high functional and relatively cost-effective system for dispensing water and a container to be used therein, preferably a reusable container.

Further object is to provide a system for dispensing water in which the water containers, which is preferably of the reusable type, are low cost.

A further object is to provide a low cost container, preferably of the reusable type, to be used in a system for dispensing water.

A further object is to provide a system for dispensing water that allows to preserve the integrity of the food liquid contained in the containers, which are of the reusable type.

The above objects, and others that will appear more clearly hereinafter, are fulfilled by a system for dispensing water and a container to be used therein according to what is herein described, shown and/or claimed.

Advantageous embodiments of the invention are defined according to the dependent claims.

### BRIEF DESCRIPTION OF THE DRAWINGS

Further features and advantages of the invention will become more apparent by reading the detailed description of a preferred but not exclusive embodiment of the invention, shown as non-limiting example with the help of the annexed figures, in which:

FIG. 1 is a schematic view of an embodiment of the container 5—food liquid dispenser system D in a first operating step;

FIGS. 2A and 2B are schematic views of the container 5—dispenser D system of FIG. 1 in different operating steps;

FIG. 3 is a schematic exploded view of the container 5—dispenser D system in a further operating step;

FIGS. 4 and 5 are axonometric views of a rigid support structure 10;

FIG. 6 is an axonometric view of a deformable bag 20;

FIG. 7 is an enlarged view of some details of the container 5;

FIG. 8A is an enlarged view of some details of FIG. 7, wherein the deformable bag 20 is of single-layer type;

FIG. 8B is an enlarged view of some details of FIG. 7, wherein the deformable bag 20 is of multilayer type.

### DETAILED DESCRIPTION OF A PREFERRED EMBODIMENT

With reference to the above mentioned figures, a system 1 for dispensing water L is described.

The system 1 may comprise a column-type dispenser 2 which may be particularly suitable to be placed in offices, waiting rooms, factories or similar places. Such column dispenser 2 may include cooling means for cooling the outflowing water in a per se known manner.

The system 1 may further comprise a water container 5 that includes a generally cylindrically shaped enlarged portion 6 and a neck 7.

In particular, such container 5, as better explained later, may be reusable.

Therefore, the container 5 may comprise a rigid support structure 10 and a deformable food bag 20 which may be particularly suitable to contain the water L. The deformable bag 20 may be placed within the rigid support structure 10.

According to a particular preferred but not exclusive embodiment of the invention shown in the annexed figures, the rigid support structure 10 may be substantially bottle shaped and may have at least one opening 11.

In other words, the rigid support structure 10 may include the generally cylindrical shaped enlarged portion 6 and the neck 7. In particular, the opening 11 may define the neck 7 of the container 5.

The deformable bag 20 may include an opening 21 to allow the water L flow into/out from it. Suitably, such opening 21 may be placed in correspondence of the opening 11 of the rigid support structure 10 and more particularly in correspondence of the neck 6 of the container 5.

On the other hand, the dispenser 2 may comprise at least one inlet for the water L contained in the deformable bag 20.

Suitably, the column dispenser 2 may include valve means of a per se known type to adjust and/or to allow the selective outflow of the water L.

The column dispenser 2 may further include a seat 3 to seat the neck 7 of the container 5, so as to couple the latter and the column dispenser 2. In particular, the neck 7 of the container 5 in the operative position may be placed below with respect to the enlarged portion 6 of the container 5.

In particular, the container 5 may be coupled with the column dispenser 2 in correspondence of the openings 11, 21 to allow the water L outflow from the bag 20 towards the column dispenser 2.

The container 5 may comprise coupling means 30 to reciprocally couple the rigid support structure 10 and the deformable bag 20.

According to a first embodiment of the invention, such coupling means 30 may be of removable type so as to allow the decoupling of the deformable bag 20 and the rigid support structure 10 so as to recycle the latter.

Suitably, the deformable bag 20 may be inserted/extracted in/from the rigid support structure through the opening 11.

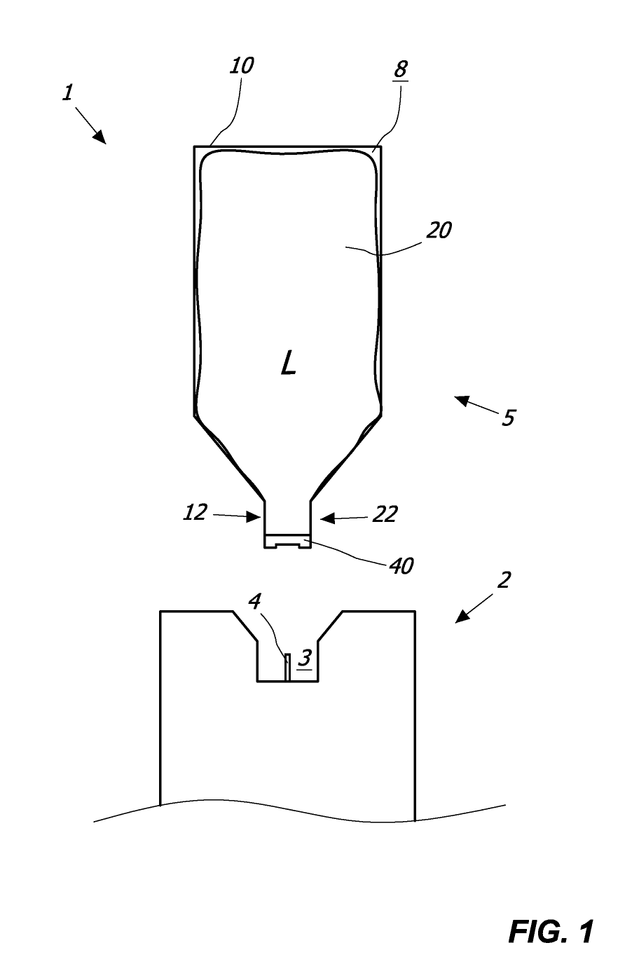

In particular, both the support structure 10 and the deformable bag 20 may include a respective portion 12, 22 for the reciprocal coupling, whereas the removable coupling means 30 may act in correspondence of the latter to couple the support structure 10 and the deformable bag 20, as shown in FIGS. 1 to 3.

The coupling portions 12, 22 may be in the proximity of the respective openings 11, 21. The latter may be substantially circular and may have respective peripheral circular edges 13, 23.

According to a particular aspect of the invention, the deformable bag 20 may be particularly suitable to be coupled with support structures 10 having different configurations. In other words, the deformable bag 20 may be inserted within the support structures 10 of a per se known types already available on the market.

The system 1 may be particularly advantageous and low cost in this way, since the reuse of the containers already available on the market are allowed.

As shown in the annexed figures, the removable coupling means 30 may comprise a removable collar 31 which may be placed in correspondence of the opening 11 and the opening 21.

More particularly, the removable collar 31 may be placed in the proximity of the circular edges 13, 23 to integrally couple the latter, and thus to integrally couple the support structure 10 and the deformable bag 20.

According to an aspect of the invention, the container 5 may include a cap 40 placed in proximity of the opening 21 of the deformable bag 20 in order to prevent the water L outflow from the same bag 20.

Thanks to this features, the container 5 may be moved and/or stored without the risk of water leakage.

The container 5 may further comprise handles graspable by the user in order to facilitate such handling operations, the handles being not shown in the figures because known per se.

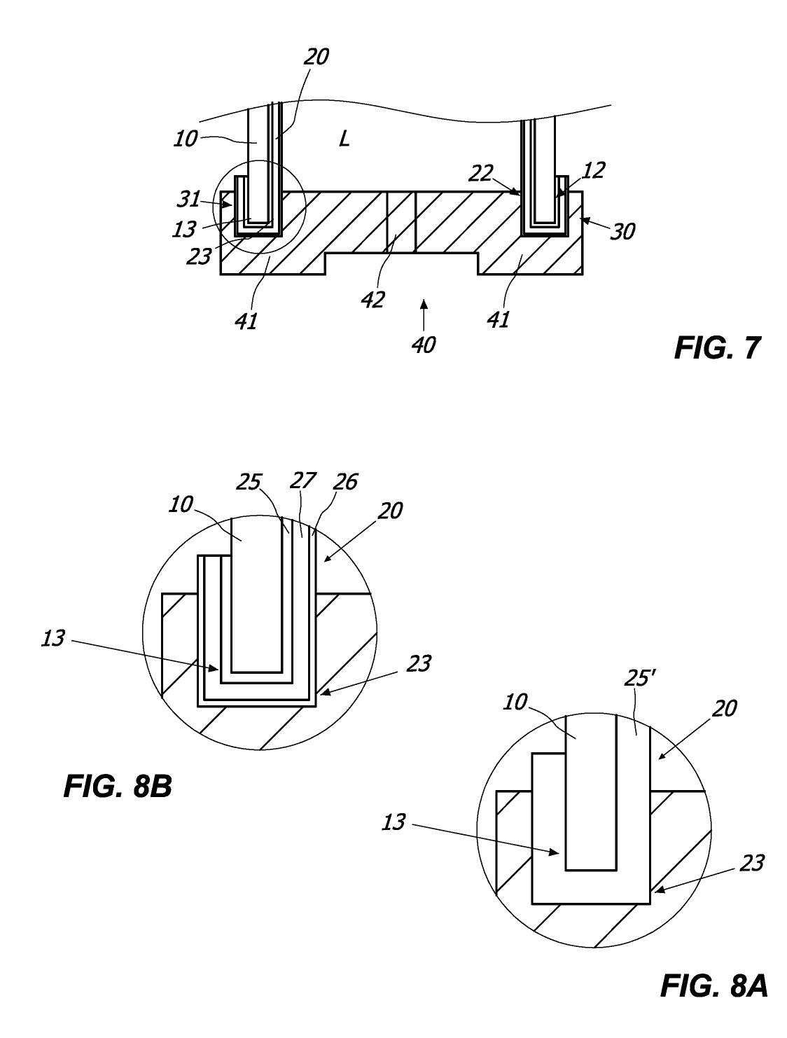

The openings 11, 21 and the cap 40 may be substantially circular shaped. In particular, as particularly shown in FIG. 7, the cap 40 may include a peripheral portion 41 which includes the removable collar 31 so that the coupling portions 12, 22 of the support structure 10 and the deformable bag 20 may be coupled by the cap 40.

Therefore, during use the empty bag 20 may be at first inserted within the rigid support structure 10 through the opening 11. Thereafter, the deformable bag 20 may be filled with water L and then the cap 40 may be provided to reciprocally integrally couple the portions 12, 22 and to prevent the water outflow from the container 5.

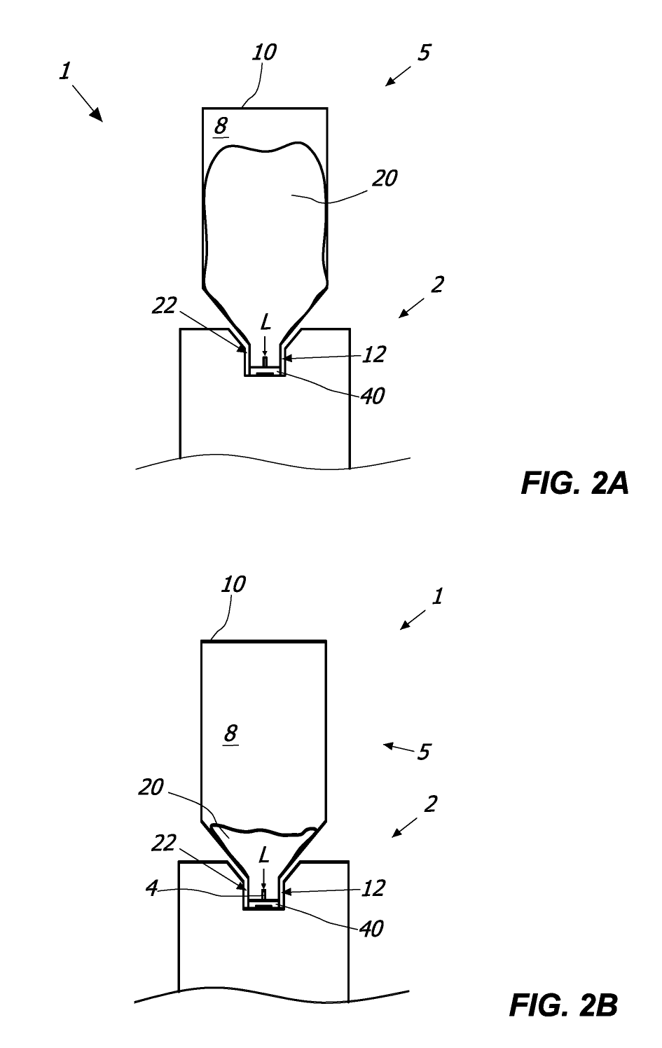

The cap 40 may have a substantially circular shape and may have a weakened central area 42. In this way, as shown in FIGS. 2A and 2B, upon the coupling of the container 5 with the column dispenser 2 a protruding portion 4 of the latter may drill the cap 40 in correspondence of the central area 42 thereof, so as to allow the water outflow from the deformable bag 20 toward the column dispenser 2.

Possibly, the peripheral zone 41 of the cap 40 may come into contact with the dispenser 2 to couple the latter and the container 5.

Thanks to such features, the deformable bag 20 and the rigid structure 10 may be easily decoupled to reuse the latter in a independently manner. In particular, the rigid structure 10 may be reused (possibly after washing) and may be immediately reused in a new container 5. For example, a new or already clean and/or sterilized and/or disinfected deformable bag 20 may be inserted within the rigid structure 10.

During the operation of the system 1, the water L may further flow from the bag 20 towards the dispenser 2 without coming into contact with the rigid support structure 10, so that the latter may be advantageously reused without the need of sterilization or similar treatments.

Possibly, the deformable bag 20 may be a disposable bag 20. To this end, the disposable bag 20 may be made of a monolayer food grade polymeric material 25′, for example polyethylene or polyamide, so as to be particularly functional and low cost.

Even in this case, the reuse of the container 5 may be significantly fast and low cost because the rigid support structure 10 does not require any sterilization treatment and may be immediately ready to house a new disposable bag 20, so as to form a new container 5. The latter may be filled with water L and coupled to the dispenser 2 as described above.

The deformable bag 20 (in particular if the latter is not of the disposable type) may be made of a multilayer material, at least one of the layers possibly being impermeable to air in order to preserve the water L contained within the same deformable bag 20.

More specifically, the multilayer material of the deformable bag 20 may have at least one first layer 25 made of a first food grade polymeric material, at least one second layer 26 made of a second polymeric material and at least one metal layer 27. The latter layer may be interposed between the first and second layers 25, 26 to prevent the inlet of pollutants within the same deformable bag 20.

For example, the polymeric layers 25, 26 may be made of polyethylene or polyamide.

The rigid support structure 10 may in turn be made of a polymeric material, preferably an optically transparent polymeric material, having high structural strength. For example, the rigid support structure 10 may be made of polyethylene terephthalate, polyamide or polycarbonate.

For this aim, the rigid support structure 10 may possibly have a plurality of folds and/or ribs suitably oriented so as to impart a high structural strength to the same rigid support structure 10.

In a preferred but not exclusive embodiment of the invention, the system 1 may be configured so as to prevent the entrance of air into the bag 20.

To this end, during the water outflow the volume of the deformable bag 20 may uniformly decrease, while the interspace 8 interposed between the deformable bag 20 and the rigid support structure 10 may be filled with air.

To ensure the integrity of the water within the container it is necessary to avoid the contact between the water flowing through the valve means and the environment air in which the dispenser 2 is inserted, which environment air being potentially a contaminant vehicle.

To this end, the rigid support structure 10 may comprise one or more passing through holes 14 to allow the air flow within the interspace 8. Possibly, this passing through hole 14 may be placed at the opposite side of the rigid support structure 10 with respect to the coupling portion 12 thereof, i.e. in correspondence of the enlarged portion 6 on the opposite side with respect to the neck 7.

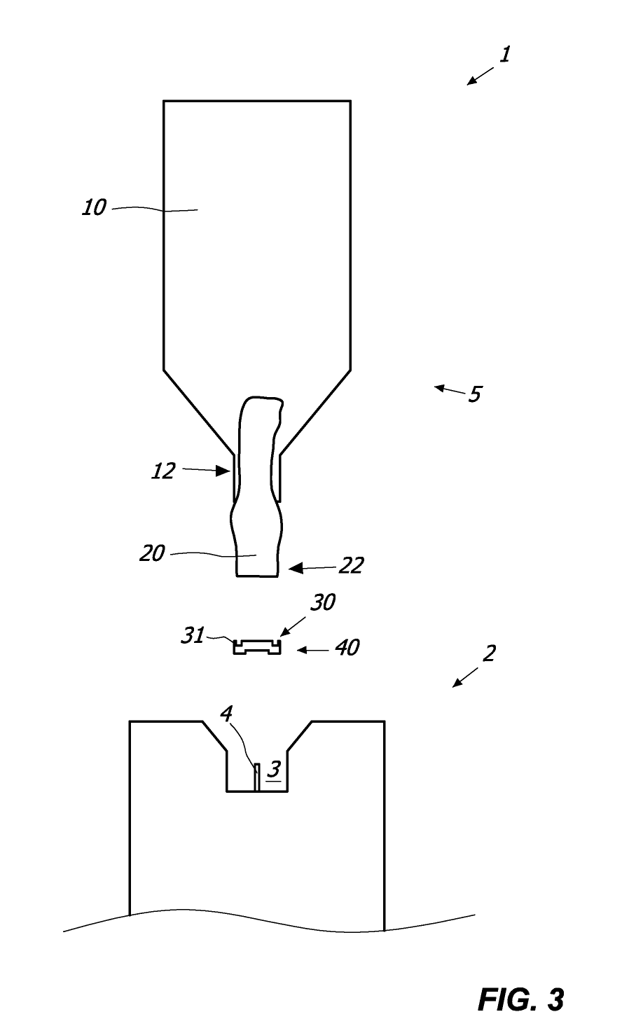

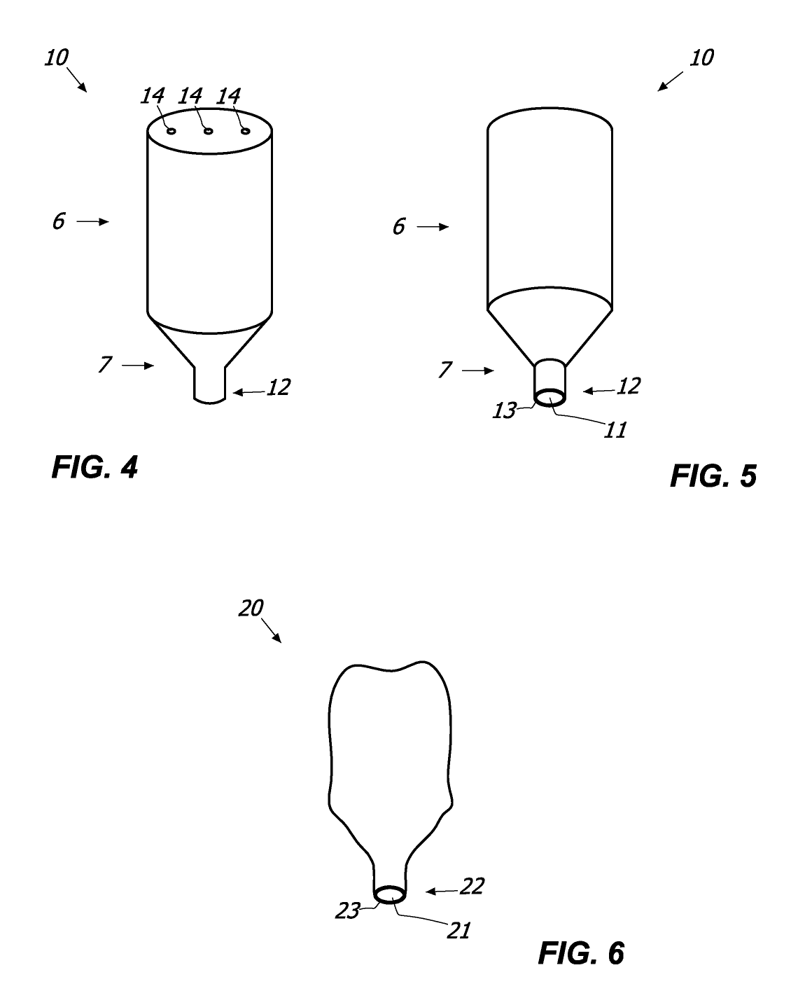

As schematically shown in FIG. 3, once the water L is drained from the deformable bag 20 and the latter has reached a minimum volume, the valve means of the dispenser 2 may be activated for occluding the fluidic line and for preserving the integrity thereof within the same dispenser 2, then the container 5 and the dispenser 2 may be decoupled, and thereafter the removable coupling means 30 may be removed so as to extract the deformable bag 20 from the rigid structure 10.

In other words, the system 1 may have a fluidic line for water L configured so that during the water outflow from the same deformable bag 20 towards the dispenser 2 the water L does not come into contact both with the rigid structure support 10 and the surrounding environment air and/or other fluids. In this way the water integrity may be preserved.

Such a feature may be particularly advantageous in the case the system 1 is used in a particularly dirty environment, such as a factory, or in environments that require high sterilization standard, such as an hospital.

It is understood that in the latter embodiment, the deformable bag 20 may be coupled with the rigid support structure 10 in a removable or fixed way. Suitably, the coupling means 30 may be configured to allow to carry out such operations.

In case the deformable bag 20 is not of the removable type, the deformable bag 20 may be further refilled and the container 5 and the dispenser 2 may be coupled again once decoupled the container 5 and the dispenser 2, thus preserving the water integrity.

On the other hand, the deformable bag 20 may be of the removable type. Thanks to this feature, as above shown, the rigid structure 10 may be immediately reused in a new container 5. For example, an already cleaned and/or sterilized and/or disinfected deformable bag 20 may be inserted within the rigid structure 10.

Possibly, a disposable bag 20 may be used also in such an embodiment.

As above shown, in this manner the reuse of the container 5 may be particularly fast and low cost.

In any case, once the water L ends, the operator may decouple the container 5 from the dispenser 2 and remove the cap 40 and/or the removable coupling means 30, the bag 20 being subsequently possibly extracted from the rigid support structure 10. Thereafter, the operator may provide a new bag 20 which may be a disinfected bag or a new bag in the case the latter is a disposable bag.

The operator may then insert the new bag 20 in the same rigid support structure 10 and fill it with water L, the support structure 10 and the bag 20 being possibly coupled again by the cap 40 and/or the removable coupling means 30.

The container 5 may then be coupled again with the dispenser 2.

The invention is susceptible to numerous modifications and variants, all included in the annexed claims. All the details may furthermore be replaced with other technically equivalent elements, and the materials may be different depending on the needs, without departing from the scope of the invention defined by the annexed claims.

1. A system for dispensing water comprising:
a container for the water, the container including a cylindrical-shaped enlarged portion and a neck;
a column type dispenser including a valve unit for the selective water outflow and a seat to seat the neck, the seat and the neck being adapted so that in the operating position the neck is placed below with respect to the enlarged portion;
wherein the container includes:
a outer rigid support structure made of polymeric material which includes the enlarged portion and the neck (7);
a deformable food bag adapted to internally contain the water, the deformable bag being placed inside the rigid support structure;
wherein the deformable bag and the rigid support structure define an interspace therebetween, the rigid support structure having a passing-through hole to allow the flow of air into the interspace;
wherein the deformable bag has a first opening placed in correspondence of the neck to avoid the contact of the outflowing water with the rigid support structure;
wherein the deformable bag is a disposable bag adapted to be removed from the rigid support structure when empty and to be replaced with a new one, the container further including a removable coupling unit for removably coupling the disposable deformable bag and the rigid support structure.

2. (canceled)

3. (canceled)

4. (canceled)

5. System according to claim 1, wherein the rigid support structure includes a second opening defining the neck, the disposable deformable bag being insertable or extractable in or from the rigid support structure through the second opening.

6. (canceled)

7. System according to claim 1, wherein the removable coupling unit comprises a removable collar adapted to be placed in correspondence of the second opening.

8. System according to claim 1, comprising a cap having a central area placed in correspondence of the first opening, the central area being adapted to be perforated upon the coupling between the container and the dispenser to allow the water outflow.

9. System according to claim 8, wherein the second opening, the first opening and the cap have a substantially circular shape, the cap further comprising a peripheral portion that includes the removable collar.

10. System according to claim 1, wherein the disposable deformable bag is made of a monolayer food grade polymeric material.

11. System according to claim 10, wherein the food grade polymeric material is polyethylene or polyamide.

12. (canceled)

13. (canceled)

14. System according to claim 1, wherein the disposable deformable bag is made of multilayer material, at least one of the layers of the multilayer material being impermeable to air.

15. System according to claim 14, wherein the multilayer material of the disposable deformable bag includes a first layer in a first food grade polymeric material a second layer in a second polymeric material and a metal layer, the metal layer being interposed between the first layer and the second layer.

16. A water container adapted to be used with a column-type dispenser in a system for dispensing water according to claim 1, the container comprising:
a outer rigid support structure made of polymeric material which includes an enlarged cylindrical-shaped portion and a neck;
a deformable food bag adapted to internally contain the water, the deformable bag being placed within the rigid support structure;
wherein the deformable bag and the rigid support structure define an interspace therebetween, the rigid support structure having a passing-through hole to allow the flow of air into the interspace;
wherein the deformable bag has a first opening placed in correspondence of the neck to avoid the contact of the outflowing water with the rigid support structure;
wherein the deformable bag is a disposable bag adapted to be removed from the rigid support structure when empty and to be replaced with a new one, the container further including a removable coupling unit for removably coupling the disposable deformable bag and the rigid support structure.

17. (canceled)

18. (canceled)

19. (canceled)

20. (canceled)
